(19) United States
(12) Patent Application Publication
(10) Pub. No.: US 2025/0051192 A1
(43) Pub. Date: Feb. 13, 2025

(54) UV LIGHT SOURCE ASSEMBLY WITH INTERCONNECTOR BOARD

(71) Applicant: TROJAN TECHNOLOGIES GROUP ULC, London (CA)

(72) Inventors: Mark Donkers, London (CA); John Vareka, London (CA); Joseph Strik, London (CA); Jeremy Silver-Mahr, London (CA); Patrick Fay, London (CA)

(73) Assignee: TROJAN TECHNOLOGIES GROUP ULC, London (CA)

(21) Appl. No.: 18/796,742

(22) Filed: Aug. 7, 2024

Related U.S. Application Data
(60) Provisional application No. 63/531,697, filed on Aug. 9, 2023.

(51) Int. Cl. C02F 1/32; F21V 23/00

(52) U.S. Cl. CPC C02F 1/325; C02F 2201/3222; C02F 2201/3225; C02F 2201/3227; C02F 2201/3228; C02F 2201/326; C02F 2303/04; F21V 23/001

(57) ABSTRACT

A light source assembly that can be connected to a reactor and which includes an board with a plurality of ultraviolet (UV) light-emitting diodes (LEDS) and a first electrical connector that is connected to a cable for supplying electrical power to the first board. The light source assembly includes an interconnector board that is separated from the LED board and which includes a second electrical connector that is connected to the cable and a third electrical connector that can connect to another cable, e.g., for supplying power to the light source assembly.

### CROSS-REFERENCE TO RELATED APPLICATIONS

This application claims the filing date benefit of U.S. Provisional Application No. 63/531,697, filed on Aug. 9, 2023. The disclosure of this prior application is incorporated by reference herein in its entirety.

### BACKGROUND

Disinfection of water is critical to ensure water quality. Water sources can be contaminated with pathogens, such as bacteria, viruses, fungi, algae, molds, and yeasts, making the water unsafe for consumption or use by humans and animals. One way of disinfecting water is by ultraviolet (UV) radiation treatment, in which water is irradiated with UV light. UV radiation damages the DNA, RNA, and protein in pathogens, and inactivates them, making the water safe for use and consumption. UV radiation treatment can be used in residential, municipal, commercial, and industrial water systems.

Conventional UV radiation treatment systems vary depending on the application, but in general, fluid flows through a treatment chamber of a reactor and is exposed to UV light from a UV light source. Different UV light sources can be used. For example, large industrial and commercial systems may include a large reactor including multiple UV lamps, such as mercury lamps, for effectively disinfecting a large volume of water. In other systems, multiple UV light-emitting diodes (LEDs) can be used as the UV light source.

For the reactor to be effective, the fluid needs to be exposed to sufficient UV radiation as it travels through the reactor, which may require the UV light source to be positioned within the treatment chamber in a way that disrupts the flow of fluid through the chamber. However, if the flow of fluid is impeded too much, it can negatively affect the efficiency of the reactor.

### SUMMARY

One object of the present disclosure is to provide an apparatus that can effectively treat fluid with UV radiation while overcoming the above challenges. For example, the UV light source can be a board with an array of UV LED lights that is electrically connected to a separate interconnector board. The use of an interconnector board with the UV LED board can enable a light source assembly with a smaller profile within the treatment chamber that diminishes the disruption of fluid flow through the reactor. The interconnector board can be positioned outside of the treatment chamber and can include various electrical components that do not necessarily need to be present on the LED board.

According to one aspect, the disclosure provides a light source assembly that includes a housing unit with (i) a first board that includes an array of UV light-emitting diodes (LEDs) and a first electrical connector that is connected to a first cable for supplying electrical power to the first board, and (ii) an interconnector board that is separated from the first board and includes (i) a second electrical connector that is connected to the first cable; and (ii) a third electrical connector that is configured to connect to a second cable.

According to another aspect, the disclosure provides an apparatus for treating a fluid with UV light. The apparatus includes (a) a reactor with an inner volume that defines a treatment chamber through which the fluid flows, and (b) a light source assembly that includes (i) a first board with a plurality of UV light-emitting diodes (LEDs) and a first electrical connector that is connected to a first cable that can supply electrical power to the first board, and (ii) an interconnector board that is separated from the first board and includes a second electrical connector that is connected to the cable, and (iii) a third electrical connector that can connect to a second cable. In this embodiment, the light source assembly is arranged so that the UV LEDs are positioned within the treatment chamber, and the interconnector board is positioned outside of the treatment chamber.

### BRIEF DESCRIPTION OF THE DRAWINGS

FIG. 1 is a perspective view of a fluid treatment system.

FIG. 2 is a perspective view of a reactor.

FIG. 3 is a cross-sectional view of the reactor taken along line A-A in FIG. 1.

FIG. 4 is a cross-sectional view of a reactor according to another embodiment.

FIG. 5A is perspective view of a light source assembly and FIG. 5B is a partial cutaway view of the light source assembly.

FIG. 6 is an exploded perspective view of a light source assembly.

FIGS. 7A and 7B are perspective views of an interconnector board.

FIG. 8 is another perspective view of the fluid treatment system illustrating the controller.

### DETAILED DESCRIPTION OF EMBODIMENTS

In the following description, numerous details are set forth to provide an understanding of the present disclosure. However, it is understood by those skilled in the art that the systems and methods of the present disclosure may be practiced without these details and that numerous variations or modifications from the described embodiments may be possible.

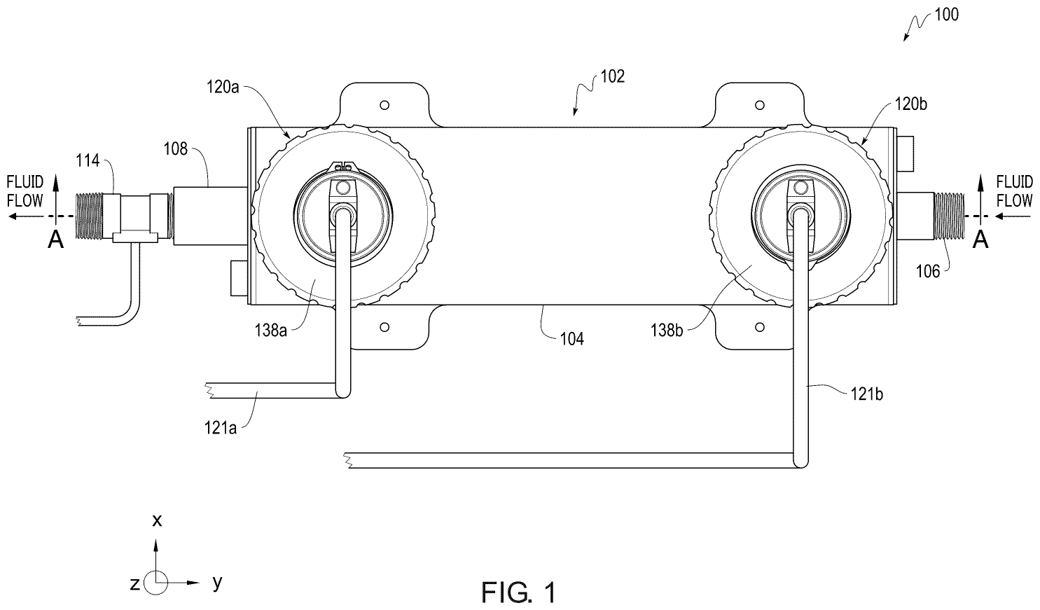

Embodiments of the present disclosure provide a fluid treatment system including at least one light source assembly that has a light source unit with an array of UV LEDs. The light source unit irradiates a fluid flowing through a reactor with UV light. The fluid treatment system can be effective to reduce the number of active pathogens in the fluid. The reactor can treat water or other aqueous fluids. The light source unit can be arranged in the reactor so as to be immersed in the fluid being treated. As described in greater detail below, the light source unit with the array of UV LEDs is electrically connected to a separate interconnector board in the light source assembly, and the interconnector board can then be further electrically connected to a controller or a power source or both. The use of the interconnector board allows the light source assembly to have a smaller profile in the treatment chamber, which can improve fluid flow. These and other features are described in detail below in connection with FIGS. 1-8.

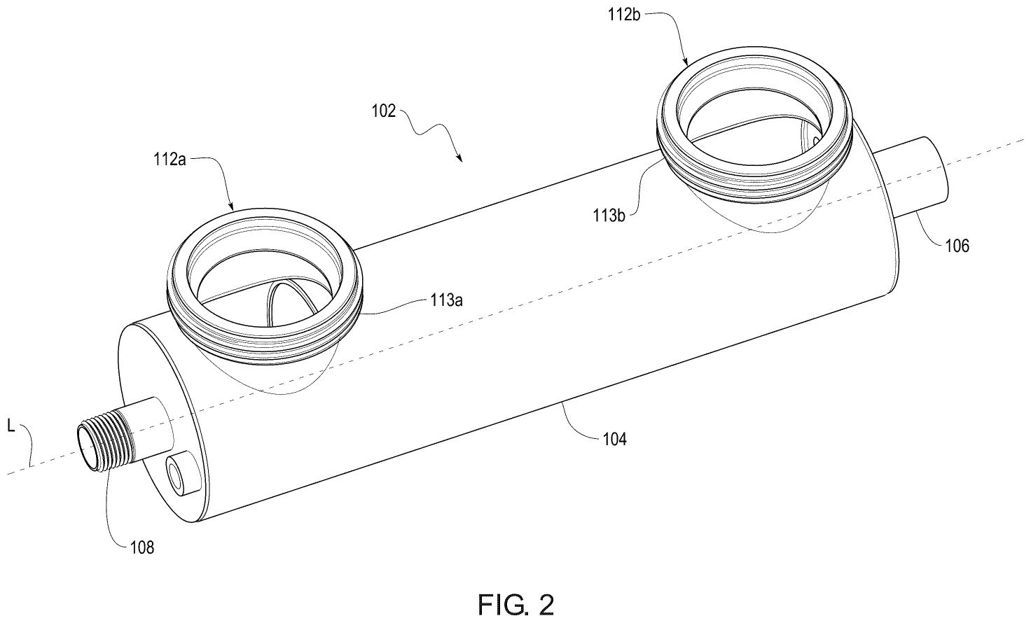

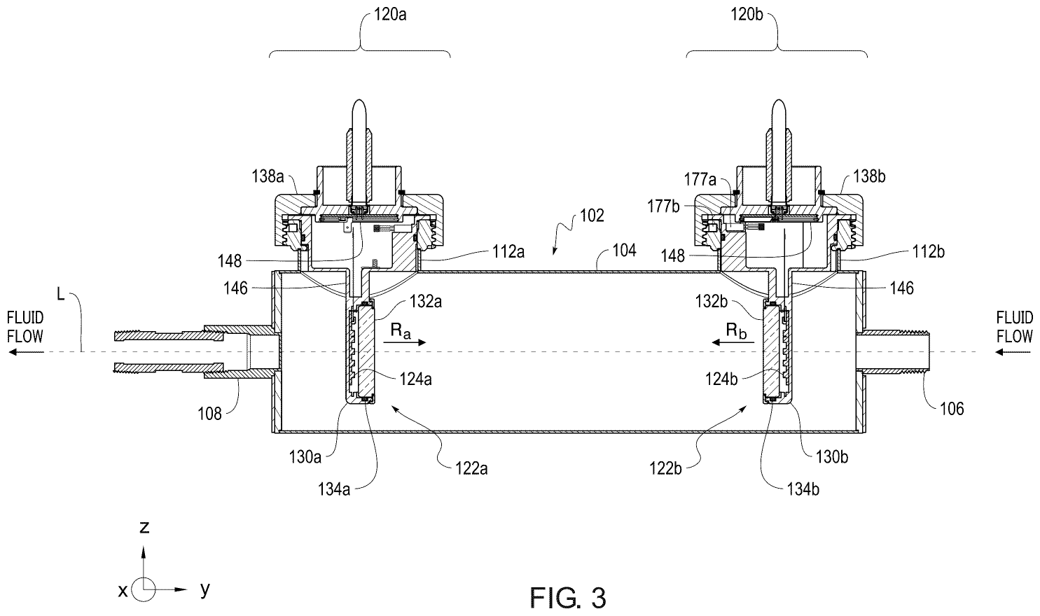

FIG. 1 shows a perspective top view of an exemplary fluid treatment system 100, FIG. 2 is a perspective view of reactor vessel 102, and FIG. 3 is a cross-sectional view of the reactor taken along line A-A in FIG. 1. As shown in FIGS. 1-3, the treatment system 100 includes an elongate reactor vessel 102 including a treatment chamber 110 for receiving a flow of fluid for UV radiation treatment. The treatment chamber 110 extends along a longitudinal axis L and includes an inlet 106 through which fluid is introduced into the treatment chamber 110 and an outlet 108 through which the fluid is discharged from the chamber 110 after being treated. The longitudinal axis L of the treatment chamber may substantially coincide with a longitudinal axis of the reactor vessel 102. The inlet 106 and the outlet 108 are in fluid communication with the treatment chamber 110, and the fluid may flow within the treatment chamber 110 from the inlet 106 to the outlet 108 generally along the longitudinal axis L of the treatment chamber. It is also possible to use other arrangements of the inlet and outlet that would cause the fluid to flow differently in the treatment chamber. For example, the inlet 106 and the outlet 108 may be arranged on opposite sides of the treatment chamber 110 along the longitudinal axis L, or the inlet 106 and outlet 108 may be arranged offset with respect to the longitudinal axis, such as along the side walls of reactor 102.

The fluid treatment system 100 may further include a flow sensor 114 for measuring a flow rate of the fluid flowing through the treatment chamber 110. As shown in FIGS. 1 and 2, the flow sensor 114 may be integrated in the outlet 108. Alternatively, the flow sensor 114 may be integrated in the inlet 106 or inside the treatment chamber 110. The fluid treatment system can also include a temperature sensor that is mounted to monitor the temperature of the fluid and/or the light source units 122a, b. The temperature sensor may be a thermistor or a thermocouple any other sensor, for example.

In one embodiment, the fluid treatment system 100 may be a residential system for disinfecting water for household use. The system 100 may be installed between a water source, such as a well or municipal water facility, and the household piping. For example, the system 100 may installed at a point of entry of the water into the household piping. The system 100 may be installed so as to be integrated with the household piping in the basement of a home at a position where the water flowing from external piping in fluid communication with a well or water treatment facility enters the home. The inlet 106 may receive water flowing from the water source, the treatment chamber may treat the water with UV radiation, making the water safe for use, and the outlet 108 may deliver the treated water to downstream household piping for household use. The treatment chamber 110 can have a volume that is in a range of about 0.25 L to 10 L, from 0.5 L to 5 L, or from 1 L to 3 L, for example. The reactor vessel 102 may be designed for a flow of fluid, such as water or other aqueous fluids (e.g., fluids including at least 75% or at least 90% water) through the treatment chamber 110 at a maximum flow rate that is in a range of 1 to 25 gallons per minute (gpm), 5 to 20 gpm, or 10 to 15 gpm. Of course, at times, the fluid in the reactor 102 may be substantially stagnant, in which case the flow rate may be less than 1 gpm, less than 0.5 gpm, or less than 0.25 gpm.

The treatment system 100 includes first and second light source assemblies 120a, 120b that are removably coupled to the reactor vessel 102. In some embodiments, the treatment system 100 may have only one light source assembly, or may have more than two light source assemblies, e.g., 3 or 4 light source assemblies. The first and second light source assemblies 120a, 120b respectively include first and second light source units 122a, 122b each with UV LEDs 124a, 124b that are arranged within the treatment chamber 110 to treat the fluid flowing through the chamber 110. The UV LEDs 124a, 124b are configured to emit UV radiation inside the treatment chamber 110 of the reactor vessel 102 to reduce the number of active pathogens in the fluid. The UV LEDs 124a, 124b may emit light in the UV spectrum, for example, in a wavelength band of about 100 nm to about 405 nm, a wavelength band of about 140 to about 330 nm, or a wavelength band of about 180 nm to about 280 nm. The UV light in the above wavelength bands has high germicidal efficacy and may kill at least 99% of microorganisms, such as bacteria, fungi, viruses, mold, and the like, in the fluid, making the fluid safe for use and consumption. The LEDs 124a, 124b may have an efficiency in converting electrical energy to UV light energy in a range of about 3% to about 30%, a range of about 4% to about 15%, or a range of about 5% to about 10%. The reactor may be designed to deliver a UV dose of 5 mJ/cm² to 100 mJ/cm², or about 30 mJ/cm², to the fluid at the target flow rate and target water quality, or may be designed to deliver any other suitable UV dose to the fluid.

Although FIGS. 1-3 show an exemplary fluid treatment system 100 in which the light source assemblies 120a, 120b are laterally or radially insertable into and removable from the treatment chamber 110, the present disclosure is not limited to this arrangement. The light source assemblies 120a, 120b may be arranged in any suitable manner for emitting UV radiation to the fluid flow through the treatment chamber 110. For example, the light source assemblies 120a, 120b may be axially insertable into and removable from the treatment chamber 110, for example, through axial ends of the treatment chamber 110. For instance, the light source assemblies 120a, 120b may be built into the axial ends of the treatment chamber 110 or reactor vessel 102 instead of being radially insertable and removable through the ports 112a, 112b. In this case, the inlet 106 and outlet 108 may be oriented radially instead of axially as shown in FIGS. 1 and 2. In such an arrangement, the light source assemblies 120a, 120b may face (e.g., emit UV light) generally towards each other along the longitudinal axis L, and the fluid flowing through the treatment chamber 110 may contact (e.g., impinge on) the windows 132a, 132b of the light source assemblies 120a, 120b, but the fluid may not contact the back side of the light source assemblies 120a, 120b or flow around the sides of the light source assemblies 120a, 120b. Alternatively, the light source assemblies 120a, 120b may be arranged in a lateral wall of the treatment chamber 110 so as to face each other (e.g., emit UV light generally towards each other) generally along a radial direction of the treatment chamber 110 orthogonal to the longitudinal axis L.

Referring to FIGS. 2 and 3, the reactor vessel 102 may have a substantially cylindrical body defined by an outer wall 104. For example, the reactor vessel 102 may have a circular cross-sectional shape. However, the present disclosure is not limited to any particular cross-sectional shape, and the reactor vessel 102 may have various other cross-sectional shapes, for example, an elliptical shape, a polygonal shape including, for example, a square or rectangular shape, and a semicircular shape. The reactor vessel 102 includes first and second lateral ports 112a, 112b including openings formed in the outer wall 104 for receiving the first and second light source assemblies 120a, 120b. However, the present disclosure is not limited this, and may have any number of ports corresponding to the number of light source assemblies. For example, the reactor vessel 102 may include at least one, at least two, or at least three ports 112, and up to twenty, up to ten, or up to five ports 112, and a corresponding number of light source assemblies. In alternative embodiments, at least one of the ports can be positioned on a longitudinal end of reactor 120 if the inlet 106 and/or outlet 108 are positioned on the circumferential sides of outer wall 104.

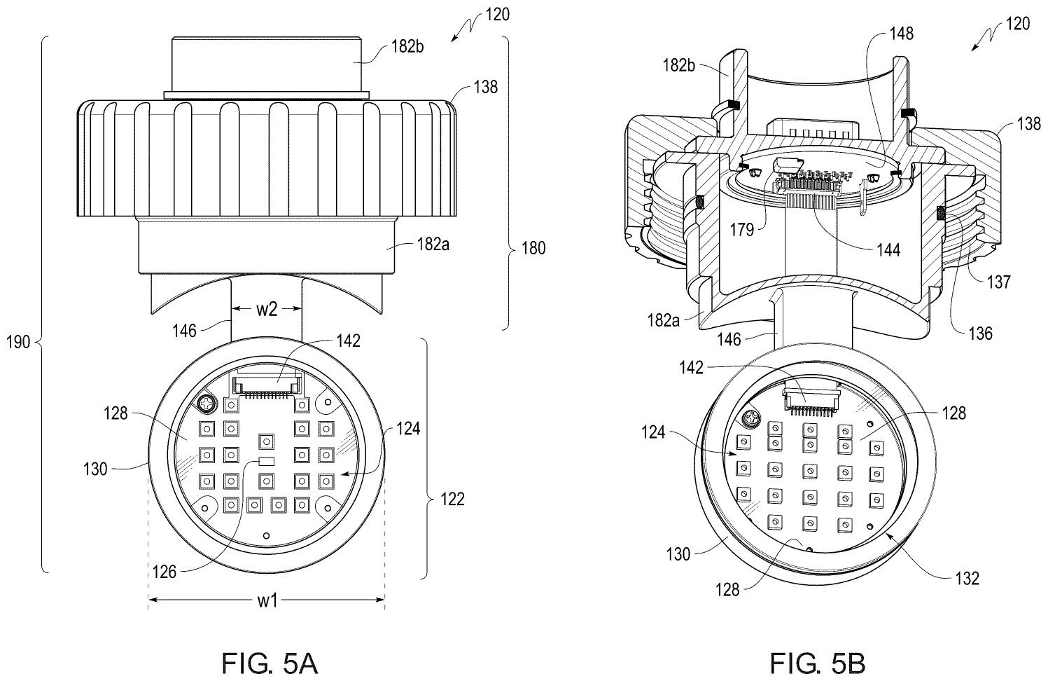

The ports 112a, 112b may include an external thread 113a, 113b designed to threadedly engage internal threads 137 (shown in FIG. 5B) of the cap 138 of the light source assembly 120. Alternatively, the ports 112a, 112b may include any other connecting mechanism suitable for positioning and detachably connecting to the light source assemblies 120a, 120b to the reactor 102.

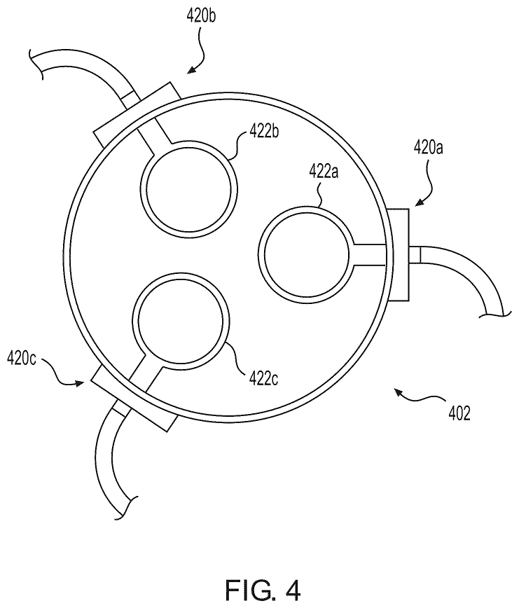

As shown in FIG. 3, the first and second light source assemblies 120a, 120b are removably coupled to the reactor vessel 102 via the caps 138a, 138b such that the first and second light source units 122a, 122b are arranged inside the treatment chamber 110 and are oriented for directing UV radiation into the fluid flowing through the treatment chamber 110. In the example shown in FIG. 3, the light source units 122a, 122b are generally concentric with the chamber 110 and have emission faces (i.e., transparent windows 132a, 132b) that extend in a plane orthogonally to both the longitudinal axis L of the treatment chamber 110 and the direction of fluid flow (along the Y direction) through the treatment chamber 110 between the inlet 106 and the outlet 108. However, the present disclosure is not limited to this, and the light source units 122a, 122b can be arranged in any suitable orientation for sufficiently treating the fluid flowing through the treatment chamber 110 with UV radiation (see, e.g., FIG. 4 described below). For example, the emission faces of the light source units 122a, 122b may be oriented at any suitable angle transverse to the longitudinal axis L of the treatment chamber 110, such as an angle in a range of 20° to 160°, a range of 30° to 150°, or a range of 45° to 135°. The emission faces of the light source units 122a, 122b may additionally or alternatively be transverse or orthogonal to the direction of fluid flow through the treatment chamber 110 so as to be oriented at an angle with respect to the direction of fluid flow in a range of 20° to 160°, a range of 30° to 150°, or a range of 45° to 135°. Similarly, the first and second LEDs 124a, 124b may be arranged in a plane that is transverse or orthogonal to the longitudinal axis L of the reactor vessel and is transverse or orthogonal to a direction of the fluid flow through the treatment chamber 110. The plane of the first and second LEDs 124a, 124b may be oriented at any suitable angle transverse to the longitudinal axis L of the treatment chamber 110, such as an angle in a range of 20° to 160°, a range of 30° to 150°, or a range of 45° to 135°.

The first and second light source units 122a, 122b can be arranged inside the treatment chamber 110 to face each other along the longitudinal axis L such that the light-emitting face, on the side of the UV transparent window 132a, 132b, of the light source units 122a, 122b face each other, and the opposite, back face of the light sources 122a, 122b face the outlet 108 and the inlet 106, respectively. As shown in FIG. 3, the first and second light source units 122a, 122b are arranged to emit UV radiation in respective directions along arrows Rₐ and R_{b} towards each other along the longitudinal axis L. The first light source unit 122a can emit UV radiation in the direction Rₐ along the longitudinal axis L toward the inlet 106, whereas a back side of the first light source unit 122a can face the outlet 108, and the second light source unit 122b can emit UV radiation in the direction R_{b} along the longitudinal axis L toward the outlet 108, whereas a backside of the second light source unit 122b can face the inlet 106. By arranging the first and second light source units 122a, 122b to face each other in this manner, the time that the fluid is exposed to the UV radiation can be extended. This can ensure that the fluid flowing through the treatment chamber is sufficiently irradiated with UV radiation for disinfecting the fluid to make it safe for use and consumption. For example, by arranging the first and second light source units 122a, 122b to face each other and emit UV radiation in directions Rₐ, R_{b} towards each other along the longitudinal axis L of the treatment chamber 110, the fluid flowing through the chamber 110 can be irradiated with UV light along substantially the entire length of the chamber 110.

The light source units 122a, 122b are arranged in the treatment chamber 110 so as to be immersed in the fluid flowing through the treatment chamber 110 for UV treatment. For example, the light source units 122a, 122b may be arranged so as to be partially or fully immersed in the fluid flowing through the treatment chamber 110. In other words, the fluid flowing through the treatment chamber 110 impinges on and flows around the light source units 122a, 122b. The fluid not only impinges on the front, light-emitting side of the light source units 122a, 122b, but also impinges on and flows around the back side of the light source units 122a, 122b, where considerable heat is often generated. Thus, the fluid being treated can be used to continuously cool the light source units 122a, 122b.

FIG. 4 shows an embodiment of a reactor vessel 402 that includes three light source assemblies 420a, 420b, 420c, that respectively include light source units 422a, 422b, 422c. In this embodiment, the light source units 420a, 420b, 420c are arranged to be generally in the same plane along a longitudinal axis of the reactor vessel 402, and are spaced equidistantly along an inner circumference of the reactor vessel 402. The light source units 420a, 420b, 420c can include emission faces that extend in a plane orthogonally the longitudinal axis of the treatment chamber and are oriented in the same direction, e.g., to emit UV radiation along a longitudinal axis of the reactor vessel 402.

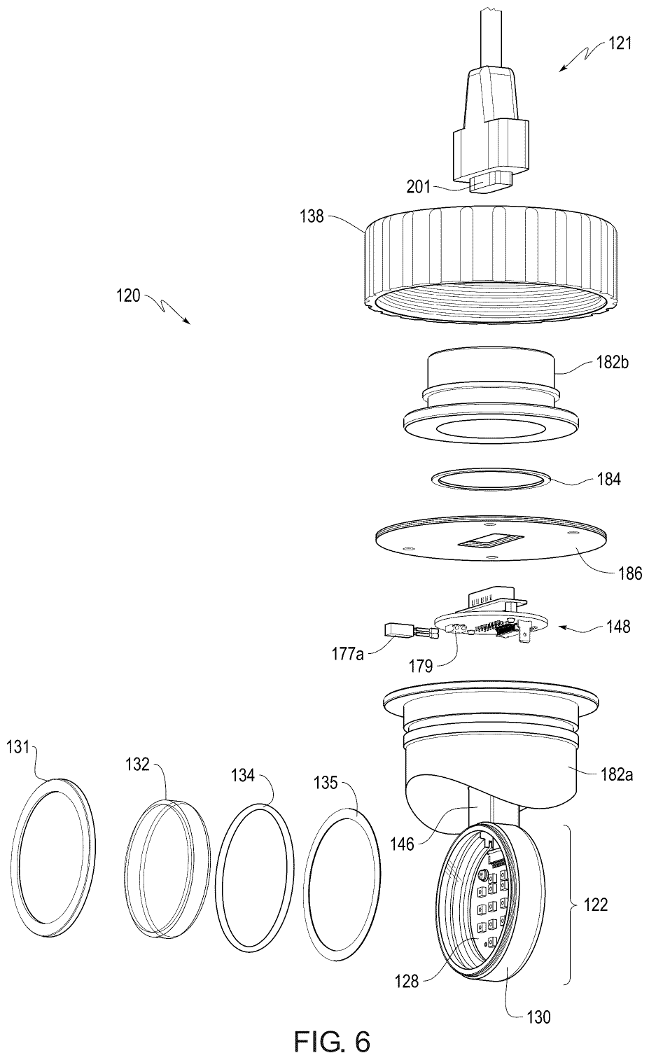

FIGS. 5A and 5B respectively show a perspective view and a partial cutaway view of an exemplary light source assembly 120, and FIG. 6 shows an exploded view of light source assembly 120. The light source assembly 120 can include a housing unit 190 that includes light source unit 122, mounting arm 146 and base housing portion 180.

The light source unit 122 of the assembly 120 can have a disc shape. For example, the light source unit may have a shape resembling a puck. However, the present disclosure is not limited to any particular shape, and the light source unit 122 may have any suitable shape, including but not limited to cylindrical, conical, frustoconical, cubical, rectangular, or the like. For example, the light source unit 122 may have a circular cross-sectional shape, as shown in FIG. 5A, 5B, and 6. However, the present disclosure is not limited to any particular cross-sectional shape, and the light source unit 122 may have various other cross-sectional shapes, for example, an elliptical shape, a polygonal shape including, for example, a square or rectangular shape, and a semicircular shape. Regardless of shape, the light source units 122a, 122b can be sized relative to the treatment chamber 110 to allow for sufficient fluid flow within the reactor 102 so that the treatment of the fluid is efficient. In this regard, a cross-sectional area of one of the light source units 122a, taken on a plane orthogonal to the longitudinal axis L, can be from 25%-60% of the cross-sectional area of the treatment chamber 110, or from 35%-45% of the cross-sectional area of the treatment chamber 110.

The light source unit 122 may include a thickness dimension that can be oriented in the treatment chamber 110 along the longitudinal axis L of the treatment chamber 110 and a width dimension that can be oriented in the treatment chamber 110 orthogonally to the longitudinal axis L of the treatment chamber 110. A maximum width dimension, w1, of the light source unit 122 may be at least twice that of a maximum thickness dimension, t1, of the light source unit 122. The maximum width dimension of the light source unit 122 may be 2 to 20 times larger than the maximum thickness dimension, 3 to 15 times larger than the maximum thickness dimension, or 5 to 10 times larger than the maximum thickness dimension of the light source unit 122. For example, in a case where the light source unit 122 is cylindrical and has a circular cross-sectional shape, the width dimension may correspond to a diameter of the light source unit 122, and the thickness dimension may correspond to a length of the cylindrical light source unit 122 that is oriented in the treatment chamber 110 along the longitudinal axis of the treatment chamber 110 and is orthogonal to the diameter of the light source unit 122.

The light source unit 122 includes a housing 130 in which UV LEDs 124 are arranged in an array. The housing 130 may be made at least partially of a heat-conductive material, such as stainless steel, aluminum, copper, or alloys thereof, to facilitate heat dissipation from the light source unit 122 to the fluid being treated in the chamber 110. For example, at least a backside of the housing 130, which is opposite to the light-emitting side, may be made of a heat-conductive material to facilitate dissipation of the heat away from the light source unit 122, e.g., into the fluid being treated.

The housing 130 may define the shape of the light source unit 122. For example, the housing 130 may have a disc shape, such as a shape resembling a puck. However, the present disclosure is not limited to any particular shape, and the housing 130 may have any suitable shape, including but not limited to cylindrical, conical, frustoconical, cubical, rectangular, or the like. For example, the housing 130 may have a circular cross-sectional shape, as shown in FIGS. 5A and 5B. However, the present disclosure is not limited to any particular cross-sectional shape, and the housing 130 may have various other cross-sectional shapes, for example, an elliptical shape, a polygonal shape including, for example, a square or rectangular shape, and a semicircular shape.

The housing 130 may include a thickness dimension that is oriented in the treatment chamber 110 along the longitudinal axis L of the treatment chamber 110 and a width dimension that is oriented in the treatment chamber 110 orthogonally to the longitudinal axis L of the treatment chamber 110. A maximum width dimension of the housing 130 may be at least twice that of a maximum thickness dimension of the housing 130. The maximum width dimension of the housing 130 may be 2 to 20 times larger than the maximum thickness dimension, 3 to 15 times larger than the maximum thickness dimension, or 5 to 10 times larger than the maximum thickness dimension of the housing 130. The maximum width dimension of housing 130 can extend in the same direction as the plane of the transparent window 132 of the light source unit 122. For example, in a case where the housing 130 is cylindrical and has a circular cross-sectional shape, the width dimension may correspond to a diameter of the housing 130, and the thickness dimension may correspond to a length of the cylindrical housing 130 that is oriented in the treatment chamber 110 along the longitudinal axis L of the treatment chamber 110 and is orthogonal to the diameter of the housing 130.

A UV transparent window 132 may be arranged on the other side (i.e., the light-emitting side) of the housing 130 so as to cover the UV LEDs 124. The UV LEDs are arranged to emit UV radiation through the UV transparent window 132. The window 132 may be made of any material that is suitably transparent to UV radiation, such as quartz or silica glass. The UV transparent window 132 may be machined and have a substantially flat surface. A plane of the UV transparent window 132 may be parallel to the width dimension of the light source unit 122 and the housing 130. The window may be sealed to prevent fluid from entering the lights source unit 122. For example, as shown in FIG. 6, the window 132 may be secured to the housing by a ring 131 or other sealing material. The ring 131 may threadedly engage external threads on the housing 130 to secure the window 132 against the array of UV LEDs 124 arranged inside the housing 130. Alternatively, the ring 131 may couple to the housing 130 by any other suitable connection mechanism. One or more O-rings 134, 135 may be used to seal the window 132 against the body of the housing 130 and to secure the opposite side of the window 132 in place over the UV LEDs 124 inside the housing 130. For example, one or more of the O-rings 134, 135 may be made of polytetrafluoroethylene (PTFE). One or both of the O-rings 134, 135 may provide a cushion to protect the window 132 from damage due to pressure in the treatment chamber 110.

The UV LEDs 124 are mounted on and electrically coupled to a circuit board 128, such as a printed circuit board (PCB) or a metal core printed circuit board (MCPCB), which is also arranged inside of the housing 130 on an opposite side of the window 132. The circuit board 128 may be inset inside the housing 130. A plane of the circuit board 128 may be oriented parallel to the width dimension of the light source unit 122 and the housing 130. The UV LEDs 124 may be arranged in any suitable pattern on the circuit board 128. The number of UV LEDs 124 arranged in the light source unit 122 may be determined based on the expected flow rate and/or desired level of disinfection. In one example, the light source unit 122 may include a number of UV LEDs 124 in a range of 5 to 100, a range of 15 to 50, or a range of 10 to 30.

The circuit board 128 may include a metal backing or metal core made of a heat-conductive material, such as copper, aluminum, and alloys thereof, in order to facilitate conducting heat away from the light source unit 122. For example, the heat generated by the light source unit 122 can be dissipated to the fluid being treated into the treatment chamber 110 through the heat-conductive backing or core and the heat-conductive housing 130. The heating-conductive backing on the circuit board 128 may be in direct contact with the thermally-conductive back of the housing 130 to facilitate heat dissipation to the fluid.

The light source unit 122 may be arranged in the treatment chamber 110 such that the UV transparent window 132, the array of LEDs 124, the circuit board 128, and the backside (non-emitted side) of the housing 130 are stacked in this order along a direction of the thickness dimension of the light source unit 122, which extends along the longitudinal axis L of the treatment chamber 110.

The treatment chamber 110 and/or the light source unit 122 may optionally include a UV reflector for facilitating irradiation of the UV light into the fluid flowing through the chamber 110. For example, the UV reflector may be made of any suitably reflective material, such as polytetrafluoroethylene (PTFE), aluminum, stainless steel, or the like. The UV reflector may be provided as a coating applied on an inner surface of the treatment chamber 110, or may be a polished inner surface of the chamber 110, for example, where the chamber wall is made of a reflective material. Alternatively or additionally, a UV reflector may be provided in the light source unit 122, for example, as a parabolic reflector or a reflective coating material, for example, provided on the circuit board 128.

The light source assembly 120 includes a mounting arm 146 that is hollow. The mounting arm 146 is connecting to the housing 130 of light source unit 122 at one end and to the base housing portion 180 at the other end. The cable 140 passes through the mounting arm 146. As shown in FIG. 3, when the light source assembly 120 is coupled to reactor 102, the mounting arm 146 extends into the treatment chamber 110. As shown in FIG. 5A, the mounting arm 146 has a maximum width dimension, w2, that extends in the same direction as the maximum width dimension, w1, of the light source unit 122. In general, w2 is smaller than w1. For example, w2 can be 10% to 50% of w1, or from 20% to 40% of w1, or from 25% to 35% of w1.

The base housing portion 180 can include housing members 182a, 182b, and cap 138 that is rotatably connected to one or both of the housing members 182a, 182b. The cap 138 has threads 135 that allow the light source assembly 120 to be removably coupled to a corresponding threaded structure on reactor 102. The housing members 182a, 182b of the base housing portion 180 include interconnector board 148. As shown in FIG. 6, the housing members 182a, 182b can couple to form an interior volume that accommodates and supports the interconnector board 148 so that the interconnector board 148 is fixed to the light source assembly 120. The base housing portion 180 can include also include O-ring 184 and spacer 186. As can be seen in FIGS. 3 and 5B, when the light source assembly 120a, 120b is assembled in reactor 102, the array of LEDs 124a, 124b is positioned in the treatment chamber 110 and the interconnector board 148 is positioned outside of the treatment chamber 110. The interconnector board 148 is electrically connected to LED board 128 via cable 140 but is physically separated from LED board 128. The interconnector board 148 can be oriented to extend in a different plane than the LED board 128. In this embodiment, the interconnector board 148 is oriented substantially orthogonally to the LED board 128.

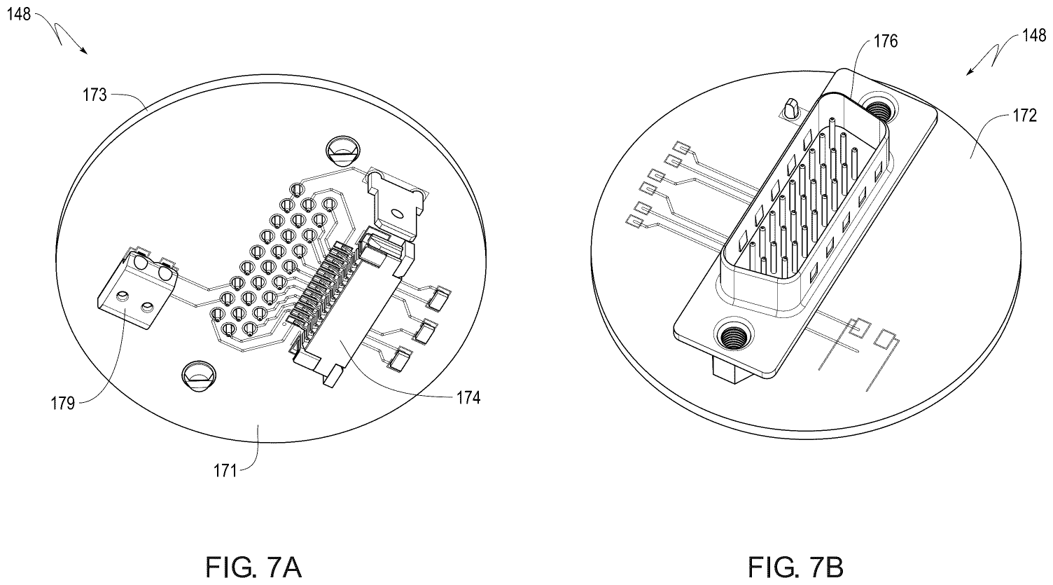

As shown in FIGS. 7A, 7B, the interconnector board 148 includes a first side 171 and a second side 172 opposite to the first side 171. When the light source unit 120 is coupled to reactor 120, the first side can face treatment chamber 110, and the second side 172 can face away from the treatment chamber 110. The interconnector board 148 can be a circuit board such as a printed circuit board (PCB) or a metal core printed circuit board (MCPCB). The interconnector board 148 can include an electrical connector 174 of a first type, and an electrical connector 176 of a second type. As shown in FIG. 5B, the electrical connector 174 can connect to a cable 140 to transmit power and/or communications signals to the light source unit 122 via cable 148 and electrical connector 142. The electrical connectors 142, 174 can be a ribbon connector that connects to a ribbon cable, such as cable 140, which may have from 4 to 25 conductors, or from 10 to 15 conductors, for example. However, other types of electrical connectors can be used as the first-type connector. The electrical connector 174 may also receive communications signals from the LED board 128 via cable 140. The electrical connector 176 can connect to cable 121 to receive power from a power source and/or to receive control signals that can sent to the LED board 128 to control operation of the light source unit 122. The electrical connector 176 can be a pin connector, e.g., with between 9 and 50 pins, such as a D-subminiature type electrical connector, for example. The connector 176 affixed to interconnector board 148 can be a male connector that connects to a female terminal 201 of cable 121. Other types of electrical connectors can also be used as the second-type connector. In general, the second-type connector 176 includes more conductor elements, e.g., pins, than the first-type of connector 174. In some case the second-type connector 176 can include from 1.5 to 3 times the number of conductors as the first-type connector 174 that connects to the cable 140 extending through the mounting arm 146. This allows the cable 140 to be smaller and thus allows the mounting arm 146 to be smaller, which can improve fluid flow through treatment chamber 110.

The interconnector board 148 can also accommodate other electronic devices, which enables the number of components on the LED board 128 to be minimized and thus allows for a smaller connector 142 on the LED board in addition to a smaller cable 140. One type of electronic device that can be included on the interconnector board 148 is a safety switch 179. The safety switch 179 can be operable to prevent electrical power from being transmitted through connector 174 if the switch 179 is triggered. The switch 179 can be connected to a magnetic proximity sensor such as a reed switch 177a that works by detecting the presence of a corresponding magnet 177b (FIG. 3) in the reactor 102. When the light assembly unit 120 is displaced or removed from the reactor 120, the reed switch 177a is activated when it is moved sufficiently far away from the magnetic field of magnet 177b, which in turn triggers switch 179 on the interconnector board 148. Once the switch 179 is triggered, power is cut to the light source unit 122. In this way, if a user attempts to disassemble the fluid treatment system, e.g., to perform maintenance or cleaning, the LED's cannot be lit when the light source assembly 120 is removed from the reactor, and the user cannot be exposed to the UV light. The use of such a proximity sensor also requires that the light source assembly 120 is correctly oriented in the reactor before the light source unit 122 is powered. A reed switch 177a is useful if the housing members 182a, 182b are made of steel because it can sense the magnetic field even through steel and can be activated if the light source assembly is dislodged or disoriented by more than 2 or 3 mm relative to the magnet 177b. As an alternative to a magnetic proximity sensor, inductive proximity sensors can be used, or two electrical contacts can be used. In either case, one portion of the sensor is located on the reactor 102 and another potion is located on the light source assembly 120. For example, as an alternative to the arrangement shown in FIG. 3, the proximity sensor can be positioned on the opposing flanges of the reactor 102 and the base housing portion 180.

Other electronic devices may be included on interconnector board 148 such as sensors (e.g., a temperature sensor), resistors, capacitors, transformers, transistors, etc.

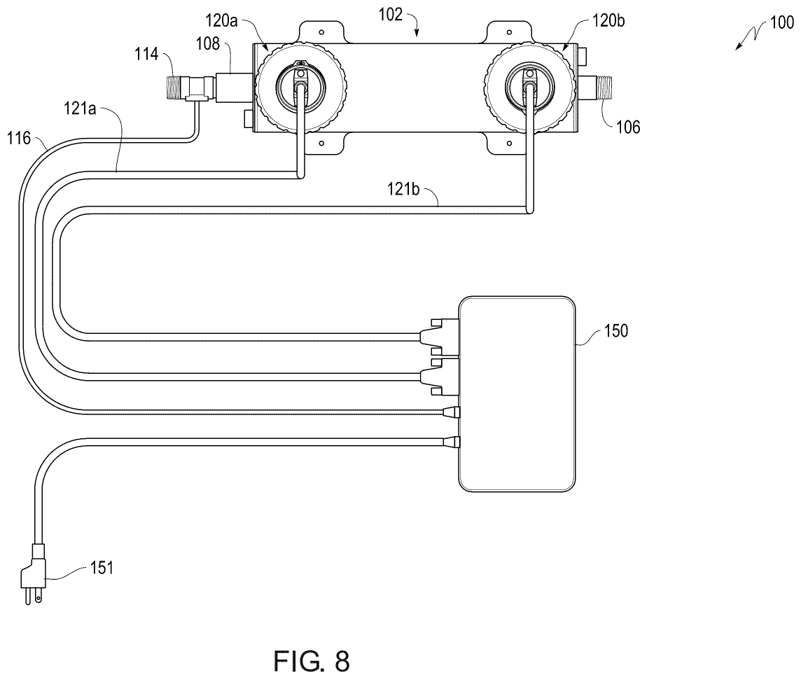

Referring now to FIG. 8, the fluid treatment system 100 may further include a controller 150 that is connected to an external power source, such as an electrical grid, via the plug 151. The controller 150 may be configured to control the transmission of electrical power to the system 100. For instance, the controller 150 may transmit power from the electrical grid to each of the light source assemblies 120a, 120b via cables 121a, 121b for powering the arrays of LEDs 124a, 124b and any sensors, such as an intensity sensor 126 or temperature sensor housed within the light source assemblies 120a, 120b. Similarly, the controller may transmit power from the electrical grid to the flow sensor 114 via cable 116. The controller 150 can include converters (e.g., AC to DC), transformers, and other components, as known in the art, to effectively convert electrical grid power to power the light source assemblies 120a, 120b.

The controller 150 may be configured to control the functioning of the system 100 based on measurements received from one or more sensors, including, for example, the flow sensor 114, the intensity sensor 126, and a temperature sensor according to the methods described above. For instance, the controller 150 may control the flow sensor 114 to periodically measure the flow rate of fluid flowing through the treatment chamber 110. The flow sensor 114 may transmit the measured flow rate to the controller 150. The controller 150 may be configured to use the measured flow rate to modulate UV LED power proportional to flow. For example, when there is low flow or no flow, the controller 150 may be configured to turn off or reduce power to the UV LEDs 124 to a low, idle power. This may include, for example, switching to pulse width modulation at the idle power.

The controller 150 may also periodically control the system 100 to evaluate the health and/or fouling of the light source units 122a, 122b by measuring the intensity of UV light using one or more intensity sensors 126 in the light source units 122a, 122b. The intensity sensor 126 may transmit the measured intensity to the controller 150. If it is determined that one or more of the light source units 122a, 122b is malfunctioning or needs servicing or maintenance, including cleaning to remove fouling materials, the controller 150 may output a notification, such as a sound, light, or other notification according to the methods discussed above.

The controller 150 includes hardware, such as a circuit for processing digital signals and a circuit for processing analog signals, for example. The controller may include one or a plurality of circuit devices (e.g., an IC) or one or a plurality of circuit elements (e.g., a resistor, a capacitor) on a circuit board, for example. The controller 150 may be a central processing unit (CPU) or any other suitable processor. The controller 150 may be or form part of a specialized or general purpose computer or processing system. One or more controllers, processors, or processing units, memory, and a bus that operatively couples various components, including the memory to the controller, may be used. The controller 150 may include a module that performs the methods described herein. The module may be programmed into the integrated circuits of the processor, or loaded from memory, storage device, or network or combinations thereof. For example, the controller 150 may execute operating and other system instructions, along with software algorithms, machine learning algorithms, computer-executable instructions, and processing functions of the fluid treatment system.

The controller 150 may be operational with numerous other general purpose or special purpose computing system environments or configurations. Examples of well-known computing systems, environments, and/or configurations that may be suitable for use with the disclosed embodiments may include, but are not limited to, personal computer systems, server computer systems, thin clients, thick clients, handheld devices, such as tablets and mobile devices, laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Although embodiments disclosed herein have been described with respect to treating water with UV radiation treatment, the present disclosure is not limited to water, and may be used to treat any fluid, including liquids, vapors, gels, plasmas, and gases. Similarly, the present disclosure is not limited to residential UV treatment systems, and may be applied to industrial, municipal, and commercial systems.

It will be appreciated that the above-disclosed features and functions, or alternatives thereof, may be desirably combined into different systems and methods. Also, various alternatives, modifications, variations or improvements may be subsequently made by those skilled in the art, and are also intended to be encompassed by the disclosed embodiments. As such, various changes may be made without departing from the spirit and scope of this disclosure.

What is claimed is:

1. A light source assembly that comprises:
a housing unit containing:
(i) a first board that includes an array of UV light-emitting diodes (LEDs) and a first electrical connector that is connected to a first cable for supplying electrical power to the first board; and
(ii) an interconnector board that is separated from the first board and includes (i) a second electrical connector that is connected to the first cable; and (ii) a third electrical connector that is configured to connect to a second cable.

2. The light source assembly of claim 1, wherein the second electrical connector and the third electrical connector are different types of electrical connectors.

3. The light source assembly of claim 2, wherein the second electrical connector has fewer conductor elements than the third electrical connector.

4. The light source assembly of claim 2, wherein the first cable is a ribbon cable.

5. The light source assembly of claim 2, wherein the third electrical connector is a pin connector.

6. The light source assembly of claim 1, wherein the housing unit includes (i) a light source housing that houses the first board and includes a transparent window that faces the array of LEDs; (ii) a base housing portion that includes the interconnector board; and (iii) a mounting arm that is connected to the light source housing at one end and to the base housing portion at another end, and through which the first cable passes.

7. The light source assembly of claim 6, wherein the base housing portion includes an end cap with a threaded portion for removably connecting the light source assembly to a structure with a corresponding threaded portion.

8. The light source assembly of claim 6, wherein the mounting arm has a maximum width dimension that is smaller than the maximum width dimension of the light source housing.

9. The light source assembly of claim 6, wherein the mounting arm has a maximum width dimension that is 10% to 50% of the maximum width dimension of the light source housing.

10. The light source assembly of claim 1, wherein the interconnector board includes a safety switch that is able to prevent power from being transmitted to the second electrical connector when the safety switch is triggered.

11. An apparatus for treating a fluid with UV light, comprising:
(a) a reactor with an inner volume that defines a treatment chamber through which the fluid flows; and
(b) a light source assembly that includes (i) a first board with a plurality of UV light-emitting diodes (LEDs) and a first electrical connector that is connected to a first cable that can supply electrical power to the first board, and (ii) an interconnector board that is separated from the first board and includes a second electrical connector that is connected to the cable; and (iii) a third electrical connector that can connect to a second cable,
wherein the light source assembly is arranged so that the UV LEDs are positioned within the treatment chamber, and the interconnector board is positioned outside of the treatment chamber.

12. The reactor of claim 11, wherein the light source assembly is removably attached to the reactor.

13. A fluid treatment system comprising the apparatus according to claim 11 and a controller that is electrically connected to the second cable and is configured to supply electrical power to the apparatus.

14. An interconnector board that includes (i) a first electrical connector of a first type that can connect to a first cable for receiving power; (ii) a second electrical connector of a second type that can connect to a second cable for transmitting power; and (iii) a safety switch that is configured to cut electrical power to the second electrical connector when it is triggered.

15. The interconnector board of claim 14, wherein the safety switch is coupled to a proximity sensor.

16. The interconnector board of claim 15, wherein the proximity sensor includes a reed switch.
